(19) United States
(12) Patent Application Publication
(10) Pub. No.: US 2008/0003411 A1
(43) Pub. Date: Jan. 3, 2008

(54) Aluminum lithographic substrate and method of making

(76) Inventors: Joseph Hunter, Fort Collins, CO (US); Carl G. Hunter, Loveland, CO (US); George C. Motoc, Lafayette, CO (US); Ronald N. Doescher, Windsor, CO (US); Kevin P. Sroka, Fort Collins, CO (US); Jen-Chi Huang, Columbus, GA (US); Oliver R. Blum, Eddigehausen-Bovenden (DE)

Correspondence Address: Paul A. Leipold, Patent Legal Staff;Eastman Kodak Company, 343 State Street, Rochester, NY, 14650-2201, US

(21) Appl. No.: 11/478,266

(22) Filed: Jun. 29, 2006

(51) Int. Cl. B41M 5/00

(52) U.S. Cl. 428/195.1

(57) ABSTRACT

Aluminum-containing metal sheets can be electrochemically grained to provide a center line average roughness (Ra) of less than 0.60 μm and an average maximum pit depth (Rv) of less than 4.5 μm using a current density of at least 50 A/dm² and a charge density less than or equal to 850 coulombs/dm². This improved metal sheet can be used as substrates for imageable elements including lithographic printing plates that exhibit reduced blanket toning.

### FIELD OF THE INVENTION

This invention relates to a method of electrochemically graining a metal sheet containing aluminum, which improved metal sheet can be used as a substrate for lithographic imaging materials.

### BACKGROUND OF THE INVENTION

In conventional or “wet” lithographic printing, ink receptive regions, known as image areas, are generated on a hydrophilic surface. When the surface is moistened with water and ink is applied, the hydrophilic regions retain the water and repel the ink, and the ink receptive regions accept the ink and repel the water. The ink is transferred to the surface of a material upon which the image is to be reproduced. For example, the ink can be first transferred to an intermediate blanket that in turn is used to transfer the ink to the surface of the material upon which the image is to be reproduced.

Imageable elements useful to prepare lithographic printing plates typically comprise an imageable layer applied over the hydrophilic surface of a substrate. The imageable layer includes one or more radiation-sensitive components that can be dispersed in a suitable binder. Alternatively, the radiation-sensitive component can also be the binder material. Following imaging, either the imaged regions or the non-imaged regions of the imageable layer are removed by a suitable developer, revealing the underlying hydrophilic surface of the substrate. If the imaged regions are removed, the element is considered as positive-working. Conversely, if the non-imaged regions are removed, the element is considered as negative-working. In each instance, the regions of the imageable layer (that is, the image areas) that remain are ink-receptive, and the regions of the hydrophilic surface revealed by the developing process accept water and aqueous solutions, typically a fountain solution, and repel ink.

Lithography has generally been carried out using a metal substrate (or “support”) such as a substrate comprising aluminum or an aluminum alloy of various metallic compositions. The surface of the metal sheet is generally roughened by surface graining in order to ensure good adhesion to a layer, usually an imageable layer, that is disposed thereon and to improve water retention in non-imaged regions during printing. Such aluminum-supported imageable elements are sometimes known in the art as precursors to planographic printing plates or lithographic printing plates.

In the past, surface graining has been carried out mechanically but recently, electrochemical or electrolytic graining methods are used, or in other instances, a combination of mechanical and electrochemical graining is used. In the electrochemical methods, an aqueous electrolytic solution containing a strong acid such as hydrochloride acid or nitric acid as the sole or primary electrolyte is used. The electrolytic graining method is capable of providing an imaged element (such as a printing plate) having excellent processability and printability, and is adaptable to continuous processing of metals in coiled form.

Various aluminum alloys are used for this purpose and these alloys have different levels of purity, affecting sheet strength, hardness, and other physical properties that affect their usefulness as substrates for printing plates. The strength of the plate also affects printing speed and durability.

Various aluminum support materials and methods of preparing them are described in U.S. Pat. No. 5,076,899 (Sakaki et al.) and U.S. Pat. No. 5,518,589 (Matsura et al.).

Thermally imageable, multi-layer elements are described, for example, U.S. Pat. No. 6,294,311 (Shimazu et al.), U.S. Pat. No. 6,352,812 (Shimazu et al.), U.S. Pat. No. 6,593,055 (Shimazu et al.), U.S. Pat. No. 6,352,811 (Patel et al.), U.S. Pat. No. 6,358,669 (Savariar-Hauck et al.), and U.S. Pat. No. 6,528,228 (Savariar-Hauck et al.), U.S. Patent Application Publications 2004/0067432 A1 (Kitson et al.) and 2005/0037280 (Loccufier et al.).

### PROBLEM TO BE SOLVED

The aluminum substrates used for lithographic printing plates require careful preparation and treatment in order for them to provide the desired quality in the resulting printed impressions. Improper preparation can result in unclear images, excessive cleaning and downtime, and considerable waste.

One problem to be avoided is what is known as “blanket toning” (or “general blanket toning”) whereby ink is absorbed by or adhered to non-imaged areas (background) on the aluminum substrate and transferred to offset printing blanket rollers. This problem may be in the form of generalized toning in the non-imaged areas or generalized toning outside of the paper area (“picture framing”). When this occurs, the blanket rollers require excessive cleaning during a press run, resulting in costly downtime for the printer, and costly paper waste from the poor background. Certain press conditions enhance the tendency for a printing plate having an aluminum substrate to absorb and transfer the ink, namely the chemistry of the fountain solution used in printing (chilled or non-chilled) or specific ink/fountain solution combinations.

Another problem is known as “localized blanket toning” (spots) resulting from the presence of residual imageable layer material in the surface pits of the non-imaged areas of the metal substrate. This residual material picks up ink and transfers it to the blanket rollers, which ink is undesirably transferred to printed sheets. This particularly problem is particularly noticeable with positive-working multilayer imageable elements.

As noted above, preparing the metal substrates for successful and efficient lithographic printing, with minimal unwanted inking of printed sheets, is not a simple task. There is considerable literature addressing various printing problems, including “blanket toning”, and a number of techniques are said to address them. However, despite this considerable teaching, there are continuing efforts to solve the “blanket toning” problem and it is to that end that the present invention is addressed.

### SUMMARY OF THE INVENTION

This invention addresses the problems noted above by providing an electrochemically grained metal sheet comprising aluminum that has a metal surface having a center line average roughness (Ra) of less than 0.60 μm and an average maximum pit depth (Rv) of less than 4.5 μm.

Other embodiments of the invention include an imageable element comprising a metal substrate comprising aluminum, the metal substrate having one or more imageable layers disposed thereon, and the metal substrate having a surface having a center line average roughness (Ra) of less than 0.60 μm and an average maximum pit depth of less than 4.5 μm. Such imageable elements are preferably lithographic printing plate precursors.

The invention also provides a method of preparing a metal sheet comprising aluminum, the method comprising:

A) electrochemically graining a metal sheet comprising aluminum at a current density of at least 50 A/dm² and a charge density less than or equal to 850 coulombs/dm², and

B) etching the surface of the electrochemically grained metal sheet with an alkaline solution to remove from about 100 mg/m².

In preferred embodiments, the electrochemically graining is carried out at a current density of from about 50 to about 80 A/dm² and a charge density of from about 450 to about 750 coulombs/dm², and the etching of the surface is carried out using a solution having a pH of at least 13 and comprising a hydroxide and a sequestering agent, at a conductivity of from about 30 to about 90 mS/cm at a temperature of from about 15 to about 45° C. to remove from about 100 to about 1000 mg/m². Following these steps, the grained and etched metal sheet can be anodized.

The present invention provides an electrochemically grained metal sheet that can be used in imageable elements such as lithographic printing plate precursors that exhibit reduced blanket toning. This desirable result is achieved by electrochemically graining the aluminum-containing sheet in a particular manner. More specifically, the substrate is electrochemically grained at a sufficiently high enough current density (amperes/dm² or A/dm²) to obtain a suitable grain structure in surface of the metal sheet. This process also has an additional benefit of reducing deposition of the etch film on the metal surface during etching.

The problem of “localized blanket toning” is reduced by controlling the applied charge density (coulombs/dm² or C/dm²) during the electrochemical graining step. Such an approach leads to a metal surface with shallower pits and a surface where the pits do not “grow” (or coalesce) into one another. The average maximum pit depth (referred to as Rv) was measured within defined surface areas using a commercially available white light interferometer (as described below). The shallower pits enhance the removal of imageable layer coating during processing (for example with an alkaline developer), and thereby reducing “localized blanket toning”. Preventing the coalescence of the pits also contributed to reduced “general blanket toning”.

These advantages are achieved by electrochemically graining the aluminum-containing sheet surface at a current density of at least 50 A/dm² and a charge density of less than or equal to 850 coulombs/dm². The grained surface can then be etched with an alkaline solution to remove at least 100 mg/m². In some embodiments, particularly when the hydrochloric acid concentration is greater than 1%, and the dissolved aluminum concentration is below 0.15%, the electrochemical graining can be carried out at a lower temperature that is below 25° C. to control pit depth. When the acid concentration is below 1% and the dissolved aluminum concentration is above 0.15%, the graining temperature can be increased above 35° C. to control pit depth.

### DETAILED DESCRIPTION OF THE INVENTION

### Definitions

Unless the context indicates otherwise, when used herein, the terms “imageable element”, “positive-working imageable element”, and “printing plate precursor” are meant to be references to embodiments of the present invention.

In addition, unless the context indicates otherwise, the various components described herein such as the components of the various layers in the imageable elements, refer to one or more of those components. Thus, the use of the article “a” or “an” is not necessarily meant to refer to only a single component.

Unless otherwise indicated, percentages refer to percents by dry weight.

As used herein, the term “radiation absorbing compound” refers to compounds that are sensitive to certain wavelengths of radiation and can convert photons into heat within the layer in which they are disposed. These compounds may also be known as “photothermal conversion materials”, “sensitizers”, or “light to heat convertors”.

For clarification of definitions for any terms relating to polymers, reference should be made to “Glossary of Basic Terms in Polymer Science” as published by the International Union of Pure and Applied Chemistry (“IUPAC”), Pure Appl. Chem. 68, 2287-2311(1996). However, any definitions explicitly set forth herein should be regarded as controlling.

Unless otherwise indicated, the term “polymer” refers to high and low molecular weight polymers including oligomers and includes homopolymers and copolymers.

The term “copolymer” refers to polymers that are derived from two or more different monomers. That is, they comprise recurring units having from about two different chemical structures.

The term “backbone” refers to the chain of atoms in a polymer to which a plurality of pendant groups can be attached. An example of such a backbone is an “all carbon” backbone obtained from the polymerization of one or more ethylenically unsaturated polymerizable monomers. However, other backbones can include heteroatoms wherein the polymer is formed by a condensation reaction or some other means. “Rv” refers to the average of the maximum pit depths measured after electrochemically graining the metal sheet surface in each of three random 450×350 μm areas in the center of the aluminum web. The maximum pit depth was measured in each area using a commercially available white light interferometer, for example a MiniFIZ interferometer, with MapVUE surface analysis software, both available from ADE-Phase Shift Technologies. (Tucson, Ariz.).

“Ra” refers to center line average roughness of the electrochemically grained metal sheet surface and can be measured using the technique described above for measuring “Rv”.

As used herein, the term “current density” is defined as the total amperage applied to one given electrode divided by the width of the aluminum web and divided by the width of the electrode. The total amperage is calculated as the root-mean-square of the instant total amperage through a given electrode averaged across each cycle of the power supply. In embodiments where the power supply is a standard sine wave alternating current (ac) source, the total amperage used in the current density calculation is equal to 0.707 times the absolute value of the peak amperage in an anodic or the cathodic portion of the ac cycle. For the demonstrated embodiments in the examples below, all electrodes were of the same width and the power supply is a standard sine wave ac power source. It should be understood that the invention can also be practiced using non-standard ac sources including, but not limited to, a standard ac source superimposed with a direct current (dc) bias and ac sources having a rectangular or a trapezoidal wave form with or without a dc bias.

In addition, as used herein, the term “charge density” is defined as the current density multiplied by the time for which the aluminum web is exposed to the applied current under the electrode. The time under each electrode used (for example, multiple electrodes were used in the examples below) is added up and multiplied by the current density as defined above (for one electrode).

### Uses

The electrochemically grained metal sheets and imageable elements of this invention can be used in a number of ways. The preferred use of the metal sheets is as substrates for precursors to lithographic printing plates as described in more detail below. However, this is not meant to be the only use of the present invention. For example, the metal sheets can be used for any application requiring the carefully prepared metal surfaces provided by the method of this invention. Moreover, the imageable elements can also be used as thermal patterning systems and to form masking elements and printed circuit boards.

### Substrate

The electrochemically grained metal sheets are composed of aluminum as the predominant component, and include sheets of aluminum alloys. Thus, the electrochemically grained metal sheets can include but are not limited to: pure aluminum sheets, sheets of aluminum alloys having small amounts (up to 10% by weight) of other elements such as manganese, silicon, iron, titanium, copper, magnesium, chromium, zinc, bismuth, nickel, or zirconium, polymeric films or papers on which aluminum or an aluminum alloy sheet can be laminated or deposited (for example, a laminate of an aluminum sheet and a polyester film). The preferred electrochemically grained metal sheets for this invention are the pure aluminum sheets or aluminum alloy sheets.

The thickness of the metal substrate can be varied but should be sufficient to sustain the wear from printing and thin enough to wrap around a printing form. Preferred metal sheet embodiments have a thickness of from about 100 to about 600 μm.

In general, the metal sheets used to prepare as substrates have the desired tensile strength, elasticity, crystallinity, conductivity, and other physical properties that are conventional in the lithographic art, which properties can be achieved using known treatments such as heat treatment, cold or hot fabrication processes, or other methods conventional in the art of aluminum alloy fabrication for lithographic substrate preparation.

The substrates can be prepared as continuous webs or coiled strips or as individual sheets cut to a desired size.

The surface of the metal sheets is then electrochemically grained to provide the advantages of this invention. The surface of the metal sheets is subjected to alternating current preferably in an electrolytic solution containing a suitable strong acid such as hydrochloric, nitric acid, or mixtures thereof. The acidic concentration of the electrolytic solution is generally from about 0.4% and preferably from about 0.7% to about 2% for hydrochloric acid, or from about 0.2% and preferably from about 0.4% to about 2.5% for nitric acid. Hydrochloric acid solutions are preferred.

Optional additives can be present in the electrolytic solution as corrosion inhibitors or stabilizers including but not limited to, metal nitrates and chlorides (such as aluminum nitrate and aluminum chloride), monoamines, diamines, aldehydes, phosphoric acid, chromic acid, boric acid, lactic acid, acetic acid, and oxalic acid.

The electrochemical graining is most commonly carried out at a temperature of from about 18 to about 50° C. and preferably from about 20° C. to about 40° C. The temperature can be optimized by routine experimentation for a given acid concentration and level of dissolved aluminum to best control pit depth.

The alternating current used in the graining process can have any desired wave form that alternates between positive and negative voltages including but not limited to, a square wave, trapezoidal wave, or sine wave. Ordinary single-phase or three-phase current can be used. Graining is carried out at a current density of from about 50 to about 200 A/dm², and preferably from about 50 to about 80 A/dm², and more preferably from about 55 to about 70 A/dm².

The charge density is generally less than or equal to 850 coulombs/dm², and preferably from about 450 and up 750 coulombs/dm², and more preferably up to 650 coulombs/dm² The appropriate current density can be chosen based on the specific acid and its concentration that are used. For example, if the hydrochloric acid concentration is from about 0.7 to about 1.1%, the charge density should be a maximum of 600 coulombs/dm² (preferably from about 500 to about 550 C/dm²). If the acid concentration is increased from about 1.1 to about 1.4%, the charge density should be a maximum of 750 C/dm² (preferably from about 550 to about 650 C/dm²).

Electrochemical graining can be carried out at the same charge density throughout the process or it the charge density can be changed in a stepwise fashion whereby each graining step is carried out at a different current density than the previous or succeeding graining step. For example, a stepwise graining process can be accomplished by successively increasing (“ramping up”) or decreasing (“ramping down”) current densities in succeeding graining steps.

The particular graining current density and the manner in which it is used are controlled to provide a surface center line average roughness (Ra) of less than 0.60 μm and preferably from about 0.28 but less than 0.60 μm.

In addition, the average maximum pit depth (Rv) in the aluminum metal surface is less than or equal to 4.5 μm and preferably from about 1.2 to about 4.5 μm and more preferably from about 1.2 to about 3.8 μm.

While this electrochemically grained metal sheet can now be used as a substrate for an imageable element, it is usually subjected to additional treatments before such uses. Generally, the electrochemically grained metal surface is etched with an alkaline solution to remove at least 100 mg/m², and preferably to remove from about 100 to about 1000 mg/m². Etching can be carried out by immersing the metal sheet in a highly acidic solution or a highly alkaline solution having a pH of at least 13 and a conductivity of from about 30 to about 90 mS/cm. It is important to remove sufficient aluminum metal in order to change its optical density, which is directly related to the “smut” level on the surface of the aluminum sheet. The amount of aluminum metal removed is a function of concentration, temperature, and dwell time in the etching process. Thus, there are many combinations of these parameters that a skilled artisan can consider in routine experimentation to find the optimum etching conditions for removing at least 100 mg/m².

The electrochemically grained and etched aluminum sheet can be further treated by anodization in an alternating current passing through a sulfuric acid solution (5-30%) at a temperature of from about 20 to about 60° C. for from about 5 to about 250 seconds to form an oxide layer on the metal surface. When phosphoric acid is used for anodization, the conditions may be varied as one skilled in the art would readily know.

An interlayer may be formed on the electrochemically grained and etched aluminum sheet to render its surface more hydrophilic by treatment with, for example, a silicate, dextrine, calcium zirconium fluoride, hexafluorosilicic acid, sodium phosphate/sodium fluoride, poly(vinyl phosphonic acid) (PVPA), vinyl phosphonic acid copolymer, poly(acrylic acid), or acrylic acid copolymer. Preferably, the electrochemically grained, etched, and anodized aluminum support is treated with PVPA using known procedures to improve surface hydrophilicity and dye stain resistance.

The backside (non-imaging side) of the aluminum substrate may be coated with antistatic agents and/or slipping layers or a matte layer to improve handling and “feel” of the imageable element.

### Imageable Elements

The electrochemically grained and etched metal sheets described above can be used as substrates for a wide variety of imageable elements including negative- and positive-working imageable elements that can be imaged and processed for use as lithographic printing plates. Such imageable elements generally include one or more ink-receptive layers disposed on the substrate that are needed in the imaging process. That is, they include one or more imageable layers besides any layers generally used as subbing layers, adhesion layers, protective cover layers, or for other non-imaging purposes.

The imageable layers (hence elements) can be made sensitive to any suitable imaging radiation including UV, visible, and infrared radiation having a maximum exposure wavelength of from about 150 to about 1500 nm. The imageable elements can be designed for imaging on a variety of apparatus and for development either off-press using conventional developer solutions or on-press using fountain solutions, printing inks, or a mixture thereof.

For example, there are numerous publications in the art relating to negative-working imageable compositions and elements that can be used in the practice of this invention. Some of those useful compositions are photosensitive and based on the use of naphthoquinonediazides, diazo resins, photosensitive polymers, or thermally-switchable polymers (that is thermally switching polymer layers from hydrophobic to hydrophilic, or vice versa).

Other useful negative-working compositions generally include a polymerizable component (such as a free-radically polymerizable monomer, oligomer, or polymer, or acid-crosslinked compound), an initiator composition (such as compounds that generate free radicals, or promote cationically or acid-catalyzed polymerization or crosslinking), appropriate sensitizers or radiation absorbing compounds for a specific radiation sensitivity (also known as photothermal conversion materials) such as carbon blacks, IR dyes, coumarins, onium salts, triazines, metallocenes, polycarboxylic acids, hexaaryl bisimidazoles, and borate salts. Of these compositions, the IR-sensitive compositions are preferred.

Some particularly useful negative-working imageable compositions and elements with which the present invention can be used include but are not limited to, those described in EP Patent Publications 770,494A1 (Vermeersch et al.), 924,570A1 (Fujimaki et al.), 1,063,103A1 (Uesugi), EP 1,182,033A1 (Fujimako et al.), EP 1,342,568A1 (Vermeersch et al.), EP 1,449,650A1 (Goto), and EP 1,614,539A1 (Vermeersch et al.), U.S. Pat. No. 4,511,645 (Koike et al.), U.S. Pat. No. 6,027,857 (Teng), U.S. Pat. No. 6,309,792 (Hauck et al.), U.S. Pat. No. 6,569,603 (Furukawa et al.), U.S. Pat. No. 6,899,994 (Huang et al.), U.S. Pat. No. 7,045,271 (Tao et al.), and U.S. Pat. No. 7,049,046 (Tao et al.), and U.S. Patent Application Publications 2003/0064318 (Huang et al.), 2004/0265736 (Aoshima et al.), 2005/0266349 (Van Damme et al.), and 2006/0019200 (Vermeersch et al.).

Preferred imageable elements of the invention can also be single- or multi-layer positive-working imageable elements that generally rely on a radiation absorbing compound dispersed within one or more polymeric binders that, upon suitable irradiation, are soluble, dispersible, or removable in alkaline developers, of which there are numerous examples in the art. Thus, the imageable layer, upon irradiation, undergoes a change in solubility properties with respect to the alkaline developer in its irradiated (exposed) regions.

Particularly preferred embodiments of this invention include imageable elements that comprise an aluminum substrate (provided according to this invention), an inner layer (also known as an “underlayer”), and an ink-receptive outer layer (also known as a “top layer” or “topcoat”) disposed over the inner layer. Before thermal imaging, the outer layer is generally not soluble, dispersible, or removable by an alkaline developer within the usual time allotted for development, but after thermal imaging, the imaged regions of the outer layer are more readily removable by or dissolvable in the alkaline developer. The inner layer is also generally removable by the alkaline developer. An infrared radiation absorbing compound (defined below) is also present in the imageable element, and is preferably present in the inner layer but may optionally be in a separate layer between the inner and outer layers.

The inner layer is disposed between the outer layer and the substrate. Typically, it is disposed directly on the substrate. The inner layer comprises a predominant first polymeric material that is removable by the developer and preferably soluble in the developer to reduce sludging of the developer. In addition, this first polymeric material is preferably insoluble in the solvent used to coat the outer layer so that the outer layer can be coated over the inner layer without dissolving the inner layer. This polymeric material is also identified herein as the “first polymeric binder” so as to distinguish it from the “second polymeric binder” described below for the outer layer. Mixtures of these first polymeric binders can be used if desired in the inner layer.

Useful first polymeric binders for the inner layer include but are not limited to, (meth)acrylonitrile polymers, (meth)acrylic resins comprising pendant carboxy groups, polyvinyl acetals, maleated wood rosins, styrene-maleic anhydride copolymers, (meth)acrylamide polymers such as polymers derived from N-alkoxyalkyl methacrylamide, polymers derived from an N-substituted cyclic imide, polymers having pendant urea or cyclic urea groups, and combinations thereof. First polymeric binders that provide resistance both to fountain solution and aggressive washes are disclosed in U.S. Pat. No. 6,294,311 (noted above) that is incorporated herein by reference.

Particularly useful first polymeric binders include (meth)acrylonitrile polymers, and polymers derived from an N-substituted cyclic imide (especially N-phenylmaleimide), a (meth)acrylamide (especially methacrylamide), a monomer having a pendant urea or cyclic urea group, and a (meth)acrylic acid (especially methacrylic acid). Preferred first polymeric binders of this type are copolymers that comprise from about 20 to about 75 mol % and preferably from about 35 to about 60 mol % of recurring units derived from N-phenylmaleimide, N-cyclohexylmaleimide, N-(4-carboxyphenyl)maleimide, N-benzylmaleimide, or a mixture thereof, from about 10 to about 50 mol % and preferably from about 15 to about 40 mol % of recurring units derived from acrylamide, methacrylamide, or a mixture thereof, and from about 5 to about 30 mol % and preferably from about 10 to about 30 mol % of recurring units derived from methacrylic acid. Other hydrophilic monomers, such as hydroxyethyl methacrylate, may be used in place of some or all of the methacrylamide. Other alkaline soluble monomers, such as acrylic acid, may be used in place of some or all of the methacrylic acid. Optionally, these polymers can also include recurring units derived from (meth)acrylonitrile or N-[2-(2-oxo-1-imidazolidinyl)ethyl]-methacrylamide.

The bakeable inner layers described in WO 2005/018934 (Kitson et al.) and U.S. Pat. No. 6,893,783 (Kitson et al.), the disclosures of which are all incorporated herein by reference, may also be used.

Other useful first polymeric binders can comprise, in polymerized form, from about 5 mol % to about 30 mol % (preferably from about 10 mol % to about 30 mol % of recurring units) derived from an ethylenically unsaturated polymerizable monomer having a carboxy group (such as acrylic acid, methacrylic acid, itaconic acid, and other similar monomers known in the art (acrylic acid and methacrylic acid are preferred), from about 20 mol % to about 75 mol % (preferably from about 35 mol % to about 60 mol %) of recurring units derived from N-phenylmaleimide, N-cyclohexylmaleimide, or a mixture thereof, optionally, from about 5 mol % to about 50 mol % (preferably when present from about 15 mol % to about 40 mol %) of recurring units derived from methacrylamide, and from about 3 mol % to about 50 mol % (preferably from about 10 mol % to about 40 mol % of one or more recurring units derived from monomer compounds of the following Structure (I):

CH₂═C(R₂)—C(═O)—NH—CH₂—OR, (I)

wherein R₁ is a C₁ to C₁₂ alkyl, phenyl, C₁ to C₁₂ substituted phenyl, C₁ to C₁₂ aralkyl, or Si(CH₃)₃, and R₂ is hydrogen or methyl. Methods of preparation of certain of these polymeric materials are disclosed in U.S. Pat. No. 6,475,692 (Jarek), the disclosure of which is incorporated herein by reference.

The first polymeric binder useful in this invention can also be hydroxy-containing polymeric material composed of recurring units derived from two or more ethylenically unsaturated monomers wherein from about 1 to about 50 mol % (preferably from about 10 to about 40 mol %) of the recurring units are derived from one or more of the monomers represented by the following Structure (II):

CH₂═C(R₃)C(═O)NR₄(CR₅R₆)ₘOH (II)

wherein R₃, R₄, R₅, R₆ are independently hydrogen, substituted or unsubstituted lower alkyl having 1 to 10 carbon atoms (such as methyl, chloromethyl, ethyl, iso-propyl, t-butyl, and n-decyl), or substituted or unsubstituted phenyl, and m is 1 to 20.

Useful embodiments of hydroxy-containing first polymeric binders can be represented by the following Structure (III):

-(A)ₓ-(B)_{y}—(C)_{z}— (III)

wherein A represents recurring units represented by the following Structure (IV):

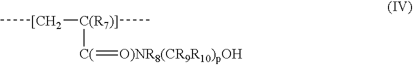

wherein R₇ through R₁₀ and p are as defined the same as R₃ through R₆ and m noted above for Structure (II).

In Structure (IV), B represents recurring units comprising acidic functionality or an N-maleimide group, and C represents recurring units different from A and B, x is from about 1 to about 50 mol % (preferably from about 10 to about 40 mol %), y is from about 40 to about 90 mol % (preferably from about 40 to about 70 mol %), and z is 0 to about 70 mol % (preferably from 0 to about 50 mol %), based on total recurring units.

In some embodiments of Structure (IV):

A represents recurring units derived from one or both of N-hydroxymethylacrylamide and N-hydroxymethylmethacrylamide,

B represents recurring units derived from one or more of N-phenylmaleimide, N-cyclohexylmaleimide, N-benzylmaleimide, N-(4-carboxyphenyl)maleimide, (meth)acrylic acid, and vinyl benzoic acid, and

C represents recurring units derived from one or more of a styrenic monomer (such as styrene and derivatives thereof), meth(acrylate) ester, N-substituted (meth)acrylamide, maleic anhydride, (meth)acrylonitrile, allyl acrylate, and a compound represented by the following Structure (V):

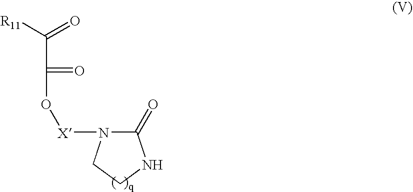

wherein R₁₁ is hydrogen, methyl, or halo, q is 1 to 3, X′ is alkylene having 2 to 12 carbon atoms, x is from about 10 to about 40 mol %, y is from about 40 to about 70 mol %, and z is from 0 to about 50 mol %, all based on total recurring units.

In other embodiments for Structure III, B represents recurring units derived from one of N-phenylmaleimide, N-cyclohexylmaleimide, N-benzylmaleimide, N-(4-carboxyphenyl)maleimide in an amount of from about 20 to about 50 mol %, and recurring units derived from one of (meth)acrylic acid and vinyl benzoic acid in an amount of from about 10 to about 30 mol %, based on total recurring units.

In such embodiments, C represents recurring units derived from methacrylamide, (meth)acrylonitrile, maleic anhydride, or

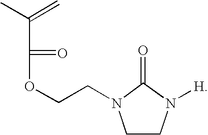

Still other useful first polymeric binders are addition or condensation polymers that have a polymer backbone having attached pendant phosphoric acid groups, pendant adamantyl groups, or both types of pendant groups. The pendant adamantyl groups are connected to the polymer backbone from about through a urea or urethane linking group but other linking groups can also be present.

First polymeric binders of this type can be represented by the following Structure (VI):

-(A)ₓ-(B)_{y}— (VI)

wherein A and B together represents the polymer backbone in which A further comprises recurring units comprising pendant phosphoric acid groups, pendant adamantyl groups, or both, B further represents different recurring units, x represents from about 5 to about 100 weight %, and y represents 0 to about 95 weight %, provided that if A comprises pendant adamantyl groups, such groups are connected to the polymer backbone through a urea or urethane linking group (but other linking groups can also be present).

Such first polymeric binders can more particularly be represented by the following Structure (VII):

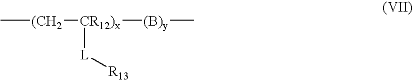

wherein R₁₂ represents hydrogen, a substituted or unsubstituted lower alkyl group having 1 to 4 carbon atoms (such as methyl, ethyl, n-propyl, or t-butyl), or a halo group.

L represents a direct bond or a linking group comprising 1 or more carbon atoms and optionally 1 or more heteroatoms in the linking chain. Useful linking groups can include, but are not limited to, substituted or unsubstituted, linear or branched alkylene groups having 1 to 10 carbon atoms (such as methylene, methoxymethylene, ethylene, iso-propylene, n-butylene, t-butylene, and n-hexylene), substituted or unsubstituted cycloalkylene groups having 5 to 10 carbon atoms in the cyclic group (such as 1,3-cyclopentylene and 1,4-cyclohexylene), substituted or unsubstituted arylene groups having 6 to 10 carbon atoms in the cyclic group (such as 1,4-phenylene, 3-methyl-1,4-phenylene, or naphthylene), or combinations thereof, such as arylenealkylene, alkylenearylene, and alkylenearylenealkylene groups. The L linking groups can also include one or more oxy, thio, amido, carbonyl, oxycarbonyl, carbonyloxy, carbonamido, sulfonamido, urea, urethane, and carbonate [—O—C(═O)—O—] groups within the linking chain, with or without any of the alkylene, cycloalkylene, and arylene groups described above. L can include combinations of two or more of these groups.

In Structure (VII), R₁₃ represents a pendant phosphoric acid group, a pendant adamantyl group, or both types of pendant groups. The solvent-resistant polymer can comprise one or more different recurring units having phosphoric acid groups or one or more different recurring units having adamantyl groups. Alternatively, the polymer can include a mixture of one or more different recurring units having phosphoric acid groups and one or more different recurring units having adamantyl groups. When R₁₃ is a pendant adamantyl group, L comprises a urea or urethane linking group within the linking chain.

In referring to “phosphoric acid” groups, it is also intended to include the corresponding salts of the phosphoric acid, including but not limited to, alkali metal salts and ammonium salts. Any suitable positive counterion can be used with the pendant phosphoric acid groups as long as the counterion does not adversely affect the performance of the resulting polymer or other desired imaging properties.

In Structures VI and VII, x is from about 5 to about 20 weight % and y is from about 80 to about 95 weight % when A represents recurring units comprising pendant phosphoric acid groups. Alternatively, x is from about 5 to about 40 weight % and B is from about 60 to about 95 weight % when A represents recurring units comprising pendant adamantyl groups.

In Structures (VI) and (VII), B represents recurring units derived from a one or more ethylenically unsaturated polymerizable monomers that do not have pendant phosphoric acid groups or adamantyl groups. A variety of monomers can be used for providing B recurring units, including styrenic monomers, (meth)acrylamide, (meth)acrylic acids or esters thereof, (meth)acrylonitrile, vinyl acetate, maleic anhydride, N-substituted maleimide, or mixtures thereof.

Preferably, the recurring units represented by B are derived from styrene, N-phenylmaleimide, methacrylic acid, (meth)acrylonitrile, or methyl methacrylate, or mixtures of two or more of these monomers.

In some embodiments, the first polymeric binder can be represented by Structure (VI) described above in which x is from about 5 to about 30 weight % (more preferably, from about 5 to about 20 weight %) and B represents recurring units derived from:

a) one or more of styrene, N-phenylmaleimide, methacrylic acid, and methyl methacrylate, wherein these recurring units comprise from 0 to about 70 weight % (more preferably from about 10 to about 50 weight %) of all recurring units in the solvent-resistant polymer, and

b) one or more of acrylonitrile or methacrylonitrile, or mixtures thereof, wherein these recurring units comprise from about 20 to about 95 weight % (more preferably from about 20 to about 60 weight %) of all recurring units in the solvent-resistant polymer.

Other useful first polymeric binders comprise a backbone and have attached to the backbone the following Structure Q group:

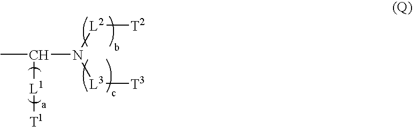

wherein L¹, L², and L³ independently represent linking groups, T¹, T², and T³ independently represent terminal groups, and a, b, and c are independently 0 or 1.

More particularly, each of L¹, L², and L³ is independently a substituted or unsubstituted alkylene having 1 to 4 carbon atoms (such as methylene, 1,2-ethylene, 1,1-ethylene, n-propylene, iso-propylene, t-butylene, and n-butylene groups), substituted cycloalkylene having 5 to 7 carbon atoms in the cyclic ring (such as cyclopentylene and 1,4-cyclohexylene), substituted or unsubstituted arylene having 6 to 10 carbon atoms in the aromatic ring (such as 1,4-phenylene, naphthylene, 2-methyl-1,4-phenylene, and 4-chloro-1,3-phenylene groups), or substituted or unsubstituted, aromatic or non-aromatic divalent heterocyclic group having 5 to 10 carbon and one or more heteroatoms in the cyclic ring (such as pyridylene, pyrazylene, pyrimidylene, or thiazolylene groups), or any combinations of two or more of these divalent linking groups. Alternatively, L² and L³ together can represent the necessary atoms to form a carbocyclic or heterocyclic ring structure. Preferably, L¹ is a carbon-hydrogen single bond or a methylene, ethylene, or phenylene group, and L² and L³ are independently hydrogen, methyl, ethyl, 2-hydroxyethyl, or cyclic —(CH₂)₂O(CH₂CH₂)— groups.

T¹, T², and T³ are independently terminal groups such as hydrogen, or substituted or unsubstituted alkyl groups having 1 to 10 carbon atoms (such as methyl, ethyl, iso-propyl, t-butyl, n-hexyl, methoxymethyl, phenylmethyl, hydroxyethyl, and chloroethyl groups), substituted or unsubstituted alkenyl groups having 2 to 10 carbon atoms (such as ethenyl and hexenyl groups), substituted or unsubstituted alkynyl groups (such as ethynyl and octynyl groups), substituted or unsubstituted cycloalkyl groups having 5 to 7 carbon atoms in the cyclic ring (such as cyclopentyl, cyclohexyl, and cycloheptyl groups), substituted or unsubstituted heterocyclic groups (both aromatic and non-aromatic) having a carbon atom and one or more heteroatoms in the ring (such as pyridyl, pyrazyl, pyrimidyl, thiazolyl, and indolyl groups), and substituted or unsubstituted aryl groups having 6 to 10 carbon atoms in the aromatic ring (such as phenyl, naphthyl, 3-methoxyphenyl, benzyl, and 4-bromophenyl groups). Alternatively, T² and T³ together represent the atoms necessary to form a cyclic structure that can also contain fused rings. In addition, when “a” is 0, T³ is not hydrogen.

In some embodiments, the Structure Q group can be directly attached to an α-carbon atom in the polymer backbone, the α-carbon atom also having attached thereto an electron withdrawing group. In other embodiments, the Structure Q group is indirectly attached to the polymer backbone through a linking group.

These first polymeric binders can be prepared by the reaction of an α-hydrogen in the polymer precursor with a first compound comprising an aldehyde group and a second compound comprising an amine group as described in U.S. Patent Application Publication 2005/0037280 (Loccufier et al.), incorporated herein by reference.

The first polymeric binders can also be represented by the following Structure (VIII):

-(A)ₓ-(B)_{y}— (VIII)

wherein A represents recurring units derived from one or more ethylenically unsaturated polymerizable monomers that comprise the same or different Q groups, B represents recurring units derived from one or more different ethylenically unsaturated polymerizable monomers that do not comprise Q groups.

More particularly, the A recurring units in Structure VIII can be represented by the following Structure (VIIIa) or (VIIIb):

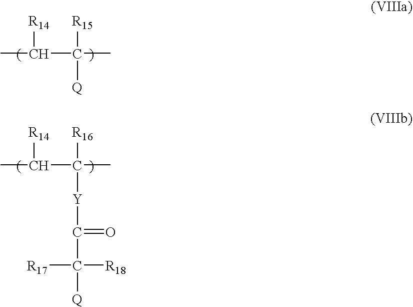

wherein R₁₄ and R₁₆ are independently hydrogen or a halo, substituted or unsubstituted alkyl having 1 to 7 carbon atoms (such as methyl, ethyl, n-propyl, iso-propyl, or benzyl), or a substituted or unsubstituted phenyl group. Preferably, R₁₄ and R₁₆ are independently hydrogen or a methyl or halo group, and more preferably they are independently hydrogen or methyl.

R₁₅ in Structure VIIIa is an electron withdrawing group as defined above including but are not limited to, cyano, nitro, substituted or unsubstituted aryl groups having 6 to 10 carbon atoms in the carbocyclic ring, substituted or unsubstituted heteroaryl groups having 5 to 10 carbon, sulfur, oxygen, or nitrogen atoms in the heteroaromatic ring, —C(═O)OR₂₀, and —C(═O)R₂₀ groups wherein R₂₀ is hydrogen or a substituted or unsubstituted alkyl having 1 to 4 carbon atoms (such as methyl, ethyl, n-propyl, t-butyl), a substituted or unsubstituted cycloalkyl (such as a substituted or unsubstituted cyclohexyl), or a substituted or unsubstituted aryl group (such as substituted or unsubstituted phenyl). The cyano, nitro, —C(═O)OR₂₀, and —C(═O)R₂₀ groups are preferred and cyano, —C(═O)CH₃, and —C(═O)OCH₃ are most preferred.

R₁₇ and R₁₈ in Structure (VIIIb) are independently hydrogen or a substituted or unsubstituted alkyl group having 1 to 6 carbon atoms (such as such as methyl, ethyl, n-propyl, t-butyl, n-hexyl), substituted or unsubstituted cycloalkyl having 5 or 6 carbon atoms (such as cyclohexyl), a substituted or unsubstituted aryl group having 6 to 10 carbon atoms (such as phenyl, 4-methylphenyl, and naphthyl), or a —C(═O)R₁₉ group wherein R₁₉ is a substituted or unsubstituted alkyl group (as defined for R₁₇ and R₁₈), a substituted or unsubstituted alkenyl group having 2 to 8 carbon atoms (such as ethenyl and 1,2-propenyl), a substituted or unsubstituted cycloalkyl group (as defined above for R₁₇ and R₁₈), or a substituted or unsubstituted aryl group (as defined above for R₁₇ and R₁₈). Preferably, R₁₇ and R₁₈ are independently hydrogen or a substituted or unsubstituted alkyl, cycloalkyl, aryl, or —C(═O)R₁₉ groups as defined above wherein R₁₉ is an alkyl having 1 to 4 carbon atoms.

In Structure (VIIIb), Y is a direct bond or a divalent linking group. Useful divalent linking groups include but are not limited to oxy, thio, —NR₂₁—, substituted or unsubstituted alkylene, substituted or unsubstituted phenylene, substituted or unsubstituted heterocyclylene, —C(═O)—, and —C(═O)O— groups, or a combination thereof wherein R₂₁ is hydrogen or a substituted or unsubstituted alkyl, substituted or unsubstituted cycloalkyl, or substituted or unsubstituted aryl group, as defined above for R₁₇ and R₁₈. Preferably, Y is a direct bond or an oxy, —C(═O)O—, —C(═O)OCH₂CH₂O—, or —C(═O)CH₂CH₂OC(═O)CH₂— group.

In Structure (VIII), x is from about 1 to about 70 mol %, and y is from about 30 to about 99 mol %, based on total recurring units. Preferably, x is from about 5 to about 50 mol % and y is from about 50 to about 95 mol %, based on total recurring units.

Also in Structure (VIII), B can represent recurring units derived from a wide variety of ethylenically unsaturated polymerizable monomers. Particularly useful recurring units are derived from one or more N-substituted maleimides, N-substituted (meth)acrylamides, unsubstituted (meth)acrylamides, (meth)acrylonitriles, or vinyl monomers having an acidic group, and more preferably from one or more N-phenylmaleimides, N-cyclohexylmaleimides, N-benzylmaleimides, N-(4-carboxyphenyl)maleimides, (meth)acrylic acids, vinyl benzoic acids, (meth)acrylamides, and (meth)acrylonitriles. Several of these monomers can be copolymerized to provide multiple types of B recurring units. Particularly useful combinations of B recurring units include those derived from two or more of methacrylic acid, methacrylamide, and N-phenylmaleimide.

The first polymeric binders are the predominant polymeric materials in the inner layer. That is, they comprise from about 50% to about 100% (dry weight) of the total polymeric materials in the inner layer. However, the inner layer may also comprise one or more primary additional polymeric materials, provided these primary additional polymeric materials do not adversely affect the chemical resistance and solubility properties of the inner layer.

Useful primary additional polymeric materials include copolymers that comprises from about 1 to about 30 mole % and preferably from about 3 to about 20 mole % of recurring units derived from N-phenylmaleimide, from about 1 to about 30 mole % and preferably from about 5 to about 20 mole % of recurring units derived from methacrylamide, from about 20 to about 75 mole % and preferably from about 35 to about 60 mole % of recurring units derived from acrylonitrile, and from about 20 to about 75 mole % and preferably from about 35 to about 60 mole % of recurring units derived from one or more monomers of the Structure (IX):

CH₂═C(R₂₃)—CO₂—CH₂CH₂—NH—CO—NH-p-C₆H₄—R₂₂ (IX)

wherein R₂₂ is OH, COOH, or SO₂NH₂, and R₂₃ is H or methyl, and, optionally, from about 1 to about 30 mole % and preferably, when present, from about 3 to about 20 mole % of recurring units derived from one or more monomers of the Structure (X):

CH₂═C(R₂₅)—CO—NH-p-C₆H₄—R₂₄ (X)

wherein R₂₄ is OH, COOH, or SO₂NH₂, and R₂₅ is H or methyl.

The inner layer may also comprise one or more secondary additional polymeric materials that are resins having activated methylol and/or activated alkylated methylol groups. These “secondary additional polymeric materials” in the inner layer should not be confused as the “second polymeric binder” used in the outer layer.

The secondary additional polymeric materials can include, for example resole resins and their alkylated analogs, methylol melamine resins and their alkylated analogs (for example melamine-formaldehyde resins), methylol glycoluril resins and alkylated analogs (for example, glycoluril-formaldehyde resins), thiourea-formaldehyde resins, guanamine-formaldehyde resins, and benzoguanamine-formaldehyde resins. Commercially available melamine-formaldehyde resins and glycoluril-formaldehyde resins include, for example, CYMEL® resins (Dyno Cyanamid) and NIKALAC® resins (Sanwa Chemical).

The resin having activated methylol and/or activated alkylated methylol groups is preferably a resole resin or a mixture of resole resins. Resole resins are well known to those skilled in the art. They are prepared by reaction of a phenol with an aldehyde under basic conditions using an excess of phenol. Commercially available resole resins include, for example, GP649D99 resole (Georgia Pacific) and BKS-5928 resole resin (Union Carbide).

Useful secondary additional polymeric materials can also include copolymers that comprise from about 25 to about 75 mole % and from about 35 to about 60 mole % of recurring units derived from N-phenylmaleimide, from about 10 to about 50 mole % and preferably from about 15 to about 40 mole % of recurring units derived from methacrylamide, and from about 5 to about 30 mole % and preferably from about 10 to about 30 mole % of recurring units derived from methacrylic acid. These secondary additional copolymers are disclosed in U.S. Pat. Nos. 6,294,311 and 6,528,228 (both noted above).

The first polymeric binder and the primary and secondary additional polymeric materials useful in the inner layer can be prepared by methods, such as free radical polymerization, that are well known to those skilled in the art and that are described, for example, in Chapters 20 and 21, of Macromolecules, Vol. 2, 2nd Ed., H. G. Elias, Plenum, New York, 1984. Useful free radical initiators are peroxides such as benzoyl peroxide, hydroperoxides such as cumyl hydroperoxide and azo compounds such as 2,2′-azobis(isobutyronitrile) (AIBN). Suitable reaction solvents include liquids that are inert to the reactants and that will not otherwise adversely affect the reaction.

In preferred embodiments, the inner layer (and preferably only the inner layer) further comprises an infrared radiation absorbing compound (“IR absorbing compounds”) that absorbs radiation from about at 600 nm to about 1500 and preferably from about at 700 nm to about 1200 nm, with minimal absorption at from about 300 to about 600 nm. This compound (sometimes known as a “photothermal conversion material”) absorbs radiation and converts it to heat. Although one of the polymeric materials may itself comprise an IR absorbing moiety, typically the infrared radiation absorbing compound is a separate compound. This compound may be either a dye or pigments such as iron oxides and carbon blacks. Examples of useful pigments are ProJet 900, ProJet 860 and ProJet 830 (all available from the Zeneca Corporation).

Useful infrared radiation absorbing compounds also include carbon blacks including carbon blacks that are surface-functionalized with solubilizing groups are well known in the art. Carbon blacks that are grafted to hydrophilic, nonionic polymers, such as FX-GE-003 (manufactured by Nippon Shokubai), or which are surface-functionalized with anionic groups, such as CAB-O-JET® 200 or CAB-O-JET® 300 (manufactured by the Cabot Corporation) are also useful.

IR absorbing dyes (especially those that are soluble in an alkaline developer) are more preferred to prevent sludging of the developer by insoluble material. Examples of suitable IR dyes include but are not limited to, azo dyes, squarilium dyes, croconate dyes, triarylamine dyes, thioazolium dyes, indolium dyes, oxonol dyes, oxaxolium dyes, cyanine dyes, merocyanine dyes, phthalocyanine dyes, indocyanine dyes, indoaniline dyes, merostyryl dyes, indotricarbocyanine dyes, oxatricarbocyanine dyes, thiocyanine dyes, thiatricarbocyanine dyes, merocyanine dyes, cryptocyanine dyes, naphthalocyanine dyes, polyaniline dyes, polypyrrole dyes, polythiophene dyes, chalcogenopyryloarylidene and bi(chalcogenopyrylo) polymethine dyes, oxyindolizine dyes, pyrylium dyes, pyrazoline azo dyes, oxazine dyes, naphthoquinone dyes, anthraquinone dyes, quinoneimine dyes, methine dyes, arylmethine dyes, squarine dyes, oxazole dyes, croconine dyes, porphyrin dyes, and any substituted or ionic form of the preceding dye classes. Suitable dyes are also described in numerous publications including U.S. Pat. No. 6,294,311 (noted above) and U.S. Pat. No. 5,208,135 (Patel et al.) and the references cited thereon, that are incorporated herein by reference.

Examples of useful IR absorbing compounds include ADS-830A and ADS-1064 (American Dye Source, Baie D'Urfe, Quebec, Canada), EC2117 (FEW, Wolfen, Germany), Cyasorb® IR 99 and Cyasorbo IR 165 (GPTGlendale Inc. Lakeland, Fla.), and IR Absorbing Dye A used in the Examples below.

Near infrared absorbing cyanine dyes are also useful and are described for example in U.S. Pat. No. 6,309,792 (Hauck et al.), U.S. Pat. No. 6,264,920 (Achilefu et al.), U.S. Pat. No. 6,153,356 (Urano et al.), U.S. Pat. No. 5,496,903 (Watanate et al.). Suitable dyes may be formed using conventional methods and starting materials or obtained from various commercial sources including American Dye Source (Canada) and FEW Chemicals (Germany). Other useful dyes for near infrared diode laser beams are described, for example, in U.S. Pat. No. 4,973,572 (DeBoer).

In addition to low molecular weight IR-absorbing dyes, IR dye moieties bonded to polymers can be used as well. Moreover, IR dye cations can be used, that is, the cation is the IR absorbing portion of the dye salt that ionically interacts with a polymer comprising carboxy, sulfo, phosphor, or phosphono groups in the side chains.

The infrared radiation absorbing compound can be present in the imageable element in an amount of generally from about 5% to about 30% and preferably from about 12 to about 25%, based on the total dry weight of the element. Preferably, this amount is based on the total dry weight of the layer in which it is located. The particular amount of a given compound to be used could be readily determined by one skilled in the art.

The inner layer can include other components such as surfactants, dispersing aids, humectants, biocides, viscosity builders, drying agents, defoamers, preservatives, antioxidants, and colorants.

The inner layer generally has a dry coating coverage of from about 0.5 to about 2.5 g/m² and preferably from about 1 to about 2 g/m². The first polymeric binders described above generally comprise from about 50 weight % and preferably from about 60 to about 90 weight % based on the total dry layer weight, and this amount can be varied depending upon what other polymers and chemical components are present. Any primary and secondary additional polymeric materials (such as a novolak, resole, or copolymers noted above) can be present in an amount of from about 5 to about 45 weight % and preferably from about 5 to about 25 weight % based on the total dry weight of the inner layer.

The ink-receptive outer layer of the imageable element is disposed over the inner layer and in preferred embodiments there are no intermediate layers between the inner and outer layers. The outer layer comprises a second polymeric material that is different than the first polymeric binder described above. The outer layer is substantially free of infrared radiation absorbing compounds, meaning that none of these compounds are purposely incorporated therein and insubstantial amounts diffuse into it from other layers.

Thus, the outer layer comprises a second polymeric binder that is a light-stable, water-insoluble, alkaline developer soluble, film-forming binder material such as phenolic resins, urethane resins, and polyacrylates. Particularly useful binder materials are described, for example in U.S. Pat. No. 6,352,812 (noted above), U.S. Pat. No. 6,358,669 (noted above), U.S. Pat. No. 6,352,811 (noted above), U.S. Pat. No. 6,294,311 (noted above), U.S. Pat. No. 6,893,783 (Kitson et al.), and U.S. Pat. No. 6,645,689 (Jarek), U.S. Patent Application Publications 2003/0108817 (Patel et al) and 2003/0162,126 (Kitson et al.), and WO 2005/018934 (Kitson et al.), all of which are incorporated herein by reference.

Particularly useful film-forming second polymeric binders for the outer layer are phenolic resins or hydroxy-containing polymers containing phenolic monomeric units that can be random, alternating, block, or graft copolymers of different monomers and may be selected from polymers of vinyl phenol, novolak resins, or resole resins. Novolak resins are preferred. The novolak or resole resins can be prepared using conventional starting materials (a hydroxy aromatic hydrocarbon and an aldehyde or ketone) and reaction conditions.

Useful poly(vinyl phenol) resins can be polymers of one or more hydroxyphenyl containing monomers such as hydroxystyrenes and hydroxyphenyl (meth)acrylates. Other monomers not containing hydroxy groups can be copolymerized with the hydroxy-containing monomers. These resins can be prepared by polymerizing one or more of the monomers in the presence of a radical initiator or a cationic polymerization initiator using known reaction conditions.

Examples of useful hydroxy-containing polymers include ALNOVOL SPN452, SPN400, HPN100 (Clariant GmbH), DURITE PD443, SD423A, SD126A, PD494A, PD-140 (Hexion Specialty Chemicals, Columbus, Ohio), BAKELITE 6866LB02, AG, 6866LB03 (Bakelite AG), KR 400/8 (Koyo Chemicals Inc.), HRJ 1085 and 2606 (Schenectady International, Inc.), and Lyncur CMM (Siber Hegner), all of which are described in U.S. Patent Application Publication 2005/0037280 (noted above). A particularly useful polymer is PD-140 that is described for use in the Examples below.

Useful novolak resins in the upper layer can be non-functionalized, or functionalized with polar groups including but not limited to, diazo groups, carboxylic acid esters (such as acetate benzoate), phosphate esters, sulfinate esters, sulfonate esters (such as methyl sulfonate, phenyl sulfonate, tosylate, 2-nitrobenzene tosylate, and p-bromophenyl sulfonate), and ethers (such as phenyl ethers). The phenolic hydroxyl groups can be converted to —T-Z groups in which “T” is a polar group and “Z” is another non-diazide functional group (as described for example in WO 99/01795 of McCullough et al. and U.S. Pat. No. 6,218,083 of McCullough et al., both incorporated herein by reference). The phenolic hydroxyl groups can also be derivatized with diazo groups containing o-naphthoquinone diazide moieties (as described for example in U.S. Pat. Nos. 5,705,308 and 5,705,322 both of West et al., both incorporated herein by reference).

It is also possible to include in the outer layer one or more “modified” phenolic resin binders that comprise phenolic recurring units that are substituted by the group represented by Structure (Q) shown above for the polymeric binders useful in the inner layer. Thus, the inner and outer layers can comprise the same or different “modified” phenolic resin binder.

Other useful second polymeric binders include copolymers of maleic anhydride and styrene or a substituted styrene or a mixture of styrene monomers. The maleic anhydride generally comprises from about 1 to about 50 mol % and preferably from about 15 to about 50 mol % of the copolymer. Additional monomers, such as (meth)acrylates, and (meth)acrylonitriles, (meth)acrylamides can also be used to provide recurring units within the copolymers.

Still other useful second polymeric binders include copolymers of one or more (meth)acrylates and one or more monomers containing a carboxy group and having 14 or less carbon atoms. Examples of useful (meth)acrylates include but are not limited to, methyl acrylate, methyl methacrylate, ethyl acrylate, ethyl methacrylate, n-butyl acrylate, and n-butyl methacrylate. Useful monomers having a carboxy group include but are not limited to, acrylic acid, methacrylic acid, 3-vinyl benzoic acid, 4-vinyl benzoic acid, itaconic acid, maleic acid, and monomers formed from the reaction of a hydroxyl-containing monomer (such as 2-hydroxyethyl acrylate and 2-hydroxyethyl methacrylate) and a cyclic anhydride (such as succinic anhydride or phthalic anhydride). The molar ratio of the (meth)acrylate monomer(s) to the carboxy-containing monomer(s) is generally from about 80:20 to about 98:2 and preferably from about 90:10 to about 95:5. Such copolymers can also include recurring units derived from one or more of maleic anhydride, vinyl ethers, (meth)acrylonitriles, and (meth)acrylamides.

Still more useful second polymeric binders are the copolymers described in U.S. Patent Application Publication 2004/0137366 (Kawauchi et al.) that comprise pendant carboxy groups directly or indirectly attached to the polymer backbone, which reference is incorporated herein by reference.

The second polymeric binder can also comprises recurring units having pendant carboxy groups that are generally represented by the following Structure (XI) or (XII), which recurring units comprise from about 3 mol % of the total recurring units in the second polymeric binder:

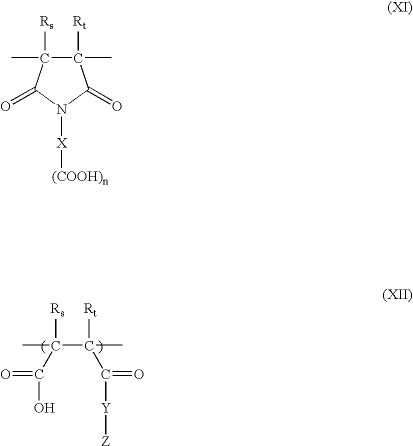

wherein n is 1 to 3 (preferably 1 or 2 and more preferably 1).

In Structure (XI) or (XII), Rₛ and Rₜ are independently hydrogen or a substituted or unsubstituted alkyl group having 1 to 7 carbon atoms (such as methyl, ethyl, t-butyl, or benzyl), or a halo group (such as chloro or bromo). Preferably, Rₛ and Rₜ are independently hydrogen or a substituted or unsubstituted methyl group or chloro group, and more preferably, they are independently hydrogen or a methyl group.

X is a multivalent linking group including but not limited to multivalent aliphatic and aromatic linking groups, and combinations thereof. In F most embodiments, X is a divalent linking group. Such groups can include alkylene, arylene, alkylenearylene, arylenealkylene, alkyleneoxyalkylene, aryleneoxyarylene, and alkyleneoxyarylene groups, all of which can be unsubstituted or substituted with one or more substituents that do not adversely affect the performance of the second polymeric binder. Preferably, X is a substituted or unsubstituted phenylene group, especially when n is 1.

In Structure (XII), Y is oxy or —NR— wherein R is hydrogen or a substituted or unsubstituted alkyl group having 1 to 10 carbon atoms (such as methyl, ethyl, iso-propyl, n-hexyl, and benzyl groups). Preferably Y is an oxy group.

Also in Structure (XII), Z is a monovalent organic group including but not limited to, a monovalent aliphatic or aromatic group, or a combination thereof. Such groups are defined similar to the multivalent groups described above for X but can also include arylene or alkylene groups, or combinations thereof, with or without carbonyl groups [C(═O)] or amido groups (—NH—) groups, or combinations thereof. For example, useful Z groups include —R′—NHC(═O)R″ groups wherein R′ is a substituted or unsubstituted alkylene group having 2 to 6 carbon atoms (such as ethylene and iso-propylene), and R″ is a substituted or unsubstituted alkyl group having 1 to about 10 carbon atoms (such as methyl, methoxymethyl, ethyl, iso-propyl, n-hexyl and benzyl groups). One particularly useful Z group is a —CH₂CH₂NHC(═O)-phenyl group.

Z can also be a substituted or unsubstituted alkyl group having 1 to 10 carbon atoms (such as methyl, ethyl, iso-propyl, t-butyl, n-hexyl, and benzyl groups). Particularly useful alkyl groups for Z include those having 1 to 8 carbon atoms (including straight-chain and branched butyl groups).

The second polymeric binder described above generally has an acid number of at least 20 mg KOH/g and preferably an acid number of from about 25 to about 45 mg KOH/g. To change the acidity of the second polymeric binder, the amount of pending carboxylic acid groups can be adjusted (for example, reduced) by reaction with an oxazoline, or by esterification with an alcohol or alkylhalogenide using known methods.

This second polymeric binder also generally has a number average molecular weight of from about 1,000 to about 250,000, and preferably from about 10,000 to about 150,000 as measured using known techniques.

Moreover, such second polymeric binders can also be represented by the following Structure (XIII):

-(A)ₓ-(B)_{y}— (XIII)

wherein A represents recurring units defined by either Structure (XI) or (XII) or both Structures (XI) and (XII). Thus, multiple types of monomers can be used to provide the A recurring units.

Also in Structure (XIII), x is from about 3 to about 15 mol % (preferably from about 5 to about 10 mol %), and y is from about 85 to about 97 mol % (preferably from about 90 to about 95 mol %).

In Structure (XIII), B represents recurring units other than those represented by A. They can be derived from one or more ethylenically unsaturated polymerizable monomers that are capable of copolymerizing with the monomers from which the A recurring units are derived, including maleic acid anhydride. Representative useful monomers for the B recurring units include but are not limited to, (meth)acrylates, (meth)acrylamides, vinyl ethers, vinyl esters, vinyl ketones, olefins, unsaturated imides including N-maleimides, unsaturated anhydrides such as maleic anhydrides, N-vinyl pyrrolidone, N-vinyl carbazole, 4-vinyl pyridine, (meth)acrylonitriles, or styrenic monomers, or any combinations of these monomers. Specific monomers of these and similar classes are described for example, in paragraphs [0044] through [0054] of U.S. Patent Application Publication 2004/0137366 that is incorporated herein by reference.

Preferably, B represents recurring units for Structure (XIII) that are derived from one or more (meth)acrylates, (meth)acrylonitriles, N-phenylmaleimide, or (meth)acrylamides such as N-alkoxyalkylmethacrylamides, or combinations of two or more of such monomers. Some particularly useful monomers from which B recurring units are derived include methyl methacrylate, styrene, ethylenically unsaturated polymerizable monomers having pendant cyclic urea groups, and combinations thereof.

The second polymeric binders comprising Structures XI and XII recurring units can be prepared using a variety of methods. For example, maleimide polymers with pendant carboxylic acid groups can be readily prepared by free radical polymerization of the maleimide monomers corresponding to the recurring units of Structure (XI) using a conventional radical initiator [such as 2,2′-azobis(iso-butyronitrile) or AIBN], or by imidization of the corresponding amine with the anhydride copolymer, in suitable solvents that are inert to the reactants. Polymers comprising Structure (XII) recurring units can be obtained by polymerization of maleic anhydride and the subsequent reaction with an alcohol or secondary amine. Polymers containing Structure (XII) recurring units are available as commercial products such as Scripset® 540 styrene-maleic anhydride copolymers (available from Hercules, Wilmington, Del.). The second polymeric binders can be homopolymers or copolymers.

The second polymeric binder is generally present in the outer layer at a dry coverage of from about 1 to about 100 weight %, and preferably from about 85 to about 100 weight %, based on total dry weight of that layer.

The outer layer can also include non-phenolic polymeric materials as film-forming binder materials in addition to or instead of the phenolic resins described above. Such non-phenolic polymeric materials include polymers formed from maleic anhydride and one or more styrenic monomers (that is styrene and styrene derivatives having various substituents on the benzene ring), polymers formed from methyl methacrylate and one or more carboxy-containing monomers, and mixtures thereof. These polymers can comprises recurring units derived from the noted monomers as well as recurring units derived from additional, but optional monomers [such as (meth)acrylates, (meth)acrylonitriles and (meth)acrylamides].

In some embodiments, the outer layer may further include a monomeric or polymeric compound that includes a benzoquinone diazide and/or naphthoquinone diazide moiety. The polymeric compounds can be phenolic resins derivatized with a benzoquinone diazide and/or naphthoquinone diazide moiety as described for example in U.S. Pat. No. 5,705,308 (West et al.) and U.S. Pat. No. 5,705,322 (West et al.) that are incorporated by reference. Mixtures of such compounds can also be used. An example of a useful polymeric compound of this type is P-3000, a naphthoquinone diazide of a pyrogallol/acetone resin (available from PCAS, France). Other useful compounds containing diazide moieties are described for example in U.S. Pat. No. 6,294,311 (noted above) and U.S. Pat. No. 5,143,816 (Mizutani et al.) that are incorporated by reference.

The monomeric or polymeric compound having a benzoquinone and/or naphthoquinone diazide moiety can be present in the outer layer generally in an amount of from about 5%, and preferably from about 10 to about 50%, based on total dry weight of the outer layer.

The outer layer can optionally include additional compounds that are colorants that may function as solubility-suppressing components for the alkali-soluble polymers. These colorants typically have polar functional groups that are believed to act as acceptor sites for hydrogen bonding with various groups in the polymeric binders. Colorants that are soluble in the alkaline developer are preferred. Useful polar groups include but are not limited to, diazo groups, diazonium groups, keto groups, sulfonic acid ester groups, phosphate ester groups, triarylmethane groups, onium groups (such as sulfonium, iodonium, and phosphonium groups), groups in which a nitrogen atom is incorporated into a heterocyclic ring, and groups that contain a positively charged atom (such as quaternized ammonium group). Further details and representative colorants are described for example in U.S. Pat. No. 6,294,311 (noted above). Particularly useful colorants include triarylmethane dyes such as ethyl violet, crystal violet, malachite green, brilliant green, Victoria blue B, Victoria blue R, and Victoria pure blue BO. These compounds can act as contrast dyes that distinguish the nonimaged areas from the imaged areas in the developed imageable element.

When a colorant is present in the outer layer, its amount can vary widely, but generally it is present in an amount of from about 0.1% to about 30%, and preferably from about 0.5 to about 15%, based on the total dry weight of the outer layer.

The outer layer can optionally also include printout or contrast dyes, surfactants, dispersing aids, humectants, biocides, viscosity builders, drying agents, defoamers, preservatives, and antioxidants. Coating surfactants are particularly useful.

The outer layer generally has a dry coating coverage of from about 0.2 to about 1 g/m² and preferably from about 0.4 to about 0.7 g/m².

Although not preferred, there may be a separate layer that is in between and in contact with the inner and outer layers. This separate layer can act as a barrier to minimize migration of radiation absorbing compound(s) from the inner layer to the outer layer. This separate “barrier” layer generally comprises a third polymeric binder that is soluble in the alkaline developer. If this third polymeric binder is different from the first polymeric binder(s) in the inner layer, it is preferably soluble in from about one organic solvent in which the inner layer first polymeric binders are insoluble. A preferred third polymeric binder is a poly(vinyl alcohol). Generally, this barrier layer should be less than one-fifth as thick as the inner layer, and preferably less than one-tenth as thick as the inner layer.

### Preparation of the Imageable Element

The imageable element can be prepared by applying one or more imageable layer formulations over the surface of the aluminum substrate of this invention (and any other hydrophilic layers provided thereon). Multiple layers can be applied in sequence, for example an inner layer formulation and then an outer layer formulation over the inner layer, using conventional coating or lamination methods. It is important to avoid intermixing of the inner and outer layer formulations.

The various layers can be applied by dispersing or dissolving the desired ingredients in a suitable coating solvent, and the resulting formulations are sequentially or simultaneously applied to the substrate using suitable equipment and procedures, such as spin coating, knife coating, gravure coating, die coating, slot coating, bar coating, wire rod coating, roller coating, or extrusion hopper coating. The formulations can also be applied by spraying onto a suitable support (such as an on-press printing cylinder).

The selection of solvents used to coat various layers (for example, inner and outer layers) depends upon the nature of the polymeric binders and other components in the formulations. For example, to prevent the inner and outer layer formulations from mixing or the inner layer from dissolving when the outer layer formulation is applied, the outer layer formulation should be coated from a solvent in which the first polymeric binder(s) of the inner layer are insoluble.

For example, an inner layer formulation can be coated out of a solvent mixture of methyl ethyl ketone (MEK), 1-methoxy-2-propyl acetate (PMA), γ-butyrolactone (BLO), and water, a mixture of MEK, BLO, water, and 1-methoxypropan-2-ol (also known as Dowanol PM or PGME), a mixture of diethyl ketone (DEK), water, methyl lactate, and BLO, a mixture of DEK, water, and methyl lactate, or a mixture of methyl lactate, methanol, and dioxolane.

An outer layer formulation can be coated out of solvents or solvent mixtures that do not dissolve the inner layer. Typical solvents for this purpose include but are not limited to, butyl acetate, iso-butyl acetate, methyl iso-butyl ketone, DEK, 1-methoxy-2-propyl acetate (PMA), iso-propyl alcohol, PGME and mixtures thereof. Particularly useful is a mixture of DEK and PMA, or a mixture of DEK, PMA, and isopropyl alcohol.

Alternatively, the formulations may be applied by extrusion coating methods from melt mixtures of the respective layer compositions. Typically, such melt mixtures contain no volatile organic solvents.

Intermediate drying steps may be used between applications of the various layer formulations to remove solvent(s) before coating other formulations. Drying steps may also help in preventing the mixing of the various layers.

After drying the layers, the imageable element (especially multi-layer imageable elements) can be further “conditioned” with a heat treatment at a temperature of from about 40 to about 90° C. for at least 4 hours (preferably at least 20 hours) under conditions that inhibit the removal of moisture from the dried layers. More preferably, the heat treatment is carried out at a temperature of from about 50 to about 70° C. for at least 24 hours. During the heat treatment, the imageable element is wrapped or encased in a water-impermeable sheet material to represent an effective barrier to moisture removal from the precursor, or the heat treatment of the imageable element is carried out in an environment in which relative humidity is controlled to at least 25%. In addition, the water-impermeable sheet material can be sealed around the edges of the imageable element, with the water-impermeable sheet material being a polymeric film or metal foil that is sealed around the edges of the imageable element.

In some embodiments, this heat treatment can be carried out with a stack comprising at least 100 of the same imageable elements (preferably from about 500 elements), or when the imageable element is in the form of a coil.

The imageable elements can have any useful form including, but not limited to, printing plate precursors, printing cylinders, printing sleeves and printing tapes (including flexible printing webs). Preferably, the imageable members are lithographic printing plate precursors useful for providing lithographic printing plates.

Printing plate precursors can be of any useful size and shape (for example, square or rectangular) having the requisite inner and outer layers disposed on a suitable substrate. Printing cylinders and sleeves are known as rotary printing members having the substrate and inner and outer layers in a cylindrical form. Hollow or solid metal cores can be used as substrates for printing sleeves.

### Imaging and Development

During use, the imageable element is exposed to a suitable source of radiation, including UV, visible and infrared radiation using a suitable source. Irradiation using an infrared laser at a wavelength of from about 600 nm to about 1500 nm and preferably at a wavelength of from about 700 nm to about 1200 nm is most preferred. The lasers used to expose the imageable elements are preferably diode lasers, because of the reliability and low maintenance of diode laser systems, but other lasers such as gas or solid-state lasers may also be used. The combination of power, intensity and exposure time for laser imaging would be readily apparent to one skilled in the art. Presently, high performance lasers or laser diodes used in commercially available imagesetters emit infrared radiation at a wavelength of from about 800 to about 850 nm or from about 1040 to about 1120 nm.

The imaging apparatus can function solely as a platesetter or it can be incorporated directly into a lithographic printing press. In the latter case, printing may commence immediately after imaging, thereby reducing press set-up time considerably. The imaging apparatus can be configured as a flatbed recorder or as a drum recorder, with the imageable member mounted to the interior or exterior cylindrical surface of the drum. Examples of useful imaging apparatus are available as models of Creo Trendsetter® imagesetters available from Creo Corporation (a subsidiary of Eastman Kodak Company, Burnaby, British Columbia, Canada) that contain laser diodes that emit near infrared radiation at a wavelength of about 830 nm. Other suitable imaging sources include the Crescent 42T Platesetter that operates at a wavelength of 1064 nm and the Screen PlateRite 4300 series or 8600 series platesetter (available from Screen, Chicago, Ill.). Additional useful sources of radiation include direct imaging presses that can be used to image an element while it is attached to the printing plate cylinder. An example of a suitable direct imaging printing press includes the Heidelberg SM74-DI press (available from Heidelberg, Dayton, Ohio).

Imaging speeds may be in the range of from about 30 to about 1500 mJ/cm², and more particularly from about 75 to about 400 mJ/cm².

While IR laser imaging is preferred in the practice of this invention, imaging can be provided by any other means that provides thermal energy in an imagewise fashion. For example, imaging can be accomplished using a thermoresistive head (thermal printing head) in what is known as “thermal printing”, as described for example in U.S. Pat. No. 5,488,025 (Martin et al.) and as used in thermal fax machines and sublimation printers. Thermal print heads are commercially available (for example, as a Fujitsu Thermal Head FTP-040 MCS001 and TDK Thermal Head F415 HH7-1089).

Imaging is generally carried out by direct digital imaging. The image signals are stored as a bitmap data file on a computer. Such files may be generated by a raster image processor (RIP) or other suitable means. The bitmaps are constructed to define the hue of the color as well as screen frequencies and angles.

Imaging of the imageable element produces an imaged element that comprises a latent image of imaged (exposed) and non-imaged (non-exposed) regions.

Both high pH and organic solvent-based developers are useful for processing imageable elements of the present invention, and particularly for processing the multi-layer imageable elements. Aqueous alkaline developers generally have a pH of at least 7 and preferably of at least 11. Useful high pH alkaline developers include 3000 Developer, 9000 Developer, GOLDSTAR Developer, GREENSTAR Developer, ThermalPro Developer, PROTHERM Developer, MX1813 Developer, and MX1710 Developer (all available from Kodak Polychrome Graphics, a subsidiary of Eastman Kodak Company). These compositions also generally include surfactants, chelating agents (such as salts of ethylenediaminetetraacetic acid), and alkaline components (such as inorganic metasilicates, organic metasilicates, hydroxides, and bicarbonates).

Solvent-based developers are generally single-phase solutions of one or more organic solvents that are miscible with water. Useful organic solvents include the reaction products of phenol with ethylene oxide and propylene oxide [such as ethylene glycol phenyl ether (phenoxyethanol)], benzyl alcohol, esters of ethylene glycol and of propylene glycol with acids having 6 or less carbon atoms, and ethers of ethylene glycol, diethylene glycol, and of propylene glycol with alkyl groups having 6 or less carbon atoms, such as 2-ethylethanol and 2-butoxyethanol. The organic solvent(s) is generally present in an amount of from about 0.5 to about 15% based on total developer weight. The solvent-based developers can be neutral, alkaline, or slightly acidic in pH but are preferably alkaline in pH.

Representative solvent-based developers include ND-1 Developer, 955 Developer, Developer 980, “2 in 1” Developer, and 956 Developer (available from Kodak Polychrome Graphics a subsidiary of Eastman Kodak Company).

Violet 500 Developer may be used for imageable elements that are imaged using “violet” light. This developer can be obtained from Kodak Polychrome Graphics, a subsidiary of Eastman Kodak Company.

For imaged positive-working imageable elements, development removes the exposed regions of one or more layer, for example, the outer layer and the underlying layers (including the inner layer), and exposes the hydrophilic surface of the substrate. The exposed (or imaged) regions of the hydrophilic surface repel ink while the non-exposed (or non-imaged) regions of the outer layer accept ink.

More particularly, development is carried out for a time sufficient to remove the imaged (exposed) regions of the outer layer and underlying layers, but not long enough to remove the non-imaged (non-exposed) regions of the outer layer. Thus, the imaged (exposed) regions of the outer layer are described as being “soluble” or “removable” in the alkaline developer because they are removed, dissolved, or dispersed within the alkaline developer more readily than the non-imaged (non-exposed) regions of the outer layer. Thus, the term “soluble” also means “dispersible”. Because of the nature of the second polymer binder(s) used in the outer layer, removal of the exposed regions readily occurs during development but the removed portions of the outer layer stay suspended or soluble in the developer solution for a longer period of time.

The imaged elements are generally developed using conventional processing conditions.

Generally, the alkaline developer is applied to the imaged element by rubbing or wiping the outer layer with an applicator containing the developer. Alternatively, the imaged element can be brushed with the developer or the developer may be applied by spraying the outer layer with sufficient force to remove the exposed regions. The imaged element is preferably immersed in the developer. In all instances, a developed image is produced, particularly in a lithographic printing plate.

Following development, the imaged element can be rinsed with water and dried in a suitable fashion. The dried element can also be treated with a conventional gumming solution (preferably gum arabic).

The imaged and developed element can also be baked in a postbake operation that can be carried out to increase run length of the resulting imaged element. Baking can be carried out, for example at a temperature of from about 220° C. to about 240° C. for a time of from about 7 to about 10 minutes, or at about 120° C. for 30 minutes.

A lithographic ink and fountain solution can be applied to the printing surface of the imaged element for printing. The ink is taken up by the oleophilic regions of the outer layer and the fountain solution is taken up by the hydrophilic surface (usually the electrochemically grained metal substrate of this invention) revealed by the imaging and development process. The ink is then transferred to a suitable receiving material (such as cloth, paper, metal, glass, or plastic) to provide a desired impression of the image thereon. An intermediate “blanket” roller is often used to transfer the ink from the imaged member to the receiving material.

The following examples are provided to illustrate the practice of the invention but are by no means intended to limit the invention in any manner.

### EXAMPLES

The components and materials used in the examples and analytical methods were as follows:

Binder A represents a copolymer of N-phenylmaleimide, methacrylamide, and methacrylic acid (40.2:34.9:24.9 mol %).

BLO represents y-butyrolactone.

DEK represents diethyl ketone.

Ethyl violet is C.I. 42600 (CAS 2390-59-2, λₘₐₓ=596 nm) having a formula of (p-(CH₃CH₂)₂NC₆H₄)₃C⁺Cl⁻ (Aldrich Chemical Company, Milwaukee, Wis., USA).

IR Dye A was obtained from Eastman Kodak Company and has the following structure:

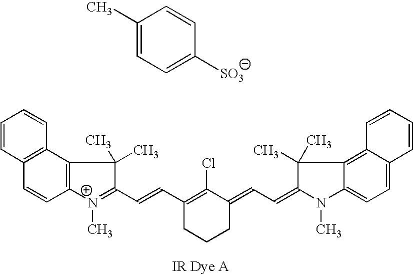

P3000 is a 215 naphthoquinonediazide sulfonate ester of pyrogallol acetone condensate that was obtained from PCAS (Longjumeau, France).

PD140A is a novolak resin (75% m-cresol and 25% p-cresol, MW 7000) that was obtained from Borden Chemical (Louisville, Ky.).

PGME represents 1-methoxypropan-2-ol (also known as Dowanol PM).

An internal press test was developed in order to accurately rank the “blanket toning” resistance of printing plates as they would be ranked in commercial print shops. Comparative and Invention aluminum substrates were coated with the layer formulations described below and the resulting imageable elements were imaged and processed using conventional techniques (for example, using commercially available 956 Developer).

The resulting printing plates were loaded side-by-side on a Miehle offset sheet-fed press. The compression transfer blanket, manufactured by Day Corporation, was cleaned with Varn's non-alcoholic V-120 cleaner. The optical density of the blanket was then measured using a conventional X-Rite densitometer with a visual filter. The ink and dampening rollers were then dropped to apply Bengal Cyan ink and 142W-Par fountain solution to the plates. After ten revolutions to condition the blanket, the form roller was dropped to transfer the blanket image to the press sheets. After 500 impressions with each printing plate, the press was stopped and the non-image areas on the blanket were measured with the densitometer. This was done again after 1000 and 1500 impressions. The average of the three readings for each transposed plate background was then used as the basis for determining “blanket toning” resistance. The printing plate that was most resistant at taking ink in the background and transferring it to the non-image areas of the blanket had the lowest optical density and therefore the best “blanket toning” resistance.

The numbers provided in the tables with the examples below represent the optical density of the blanket relative to the optical density of the blanket for Substrate C1 in Comparative Example 1 that was normalized to zero. The “blanket toning” resistance values for all of the printing plates were compared to Substrate C1. Such values of the comparative printing plates were made absolute, so the high value indicates improved “blanket toning” resistance. Levels of reproducibility were 0.03 for the Invention printing plates. Therefore, an optical density measurement of 0.89, for example, was viewed as having a range of 0.875 to 0.905. For a printing plate to have improved “blanket toning” resistance, the value had to be from about 0.03 higher.

All Invention and Comparative imageable elements were prepared by coating the described aluminum substrates with an inner layer formulation and then an outer layer formulation, described as follows:

The inner layer formulation comprised a solution of Binder A (85 parts by weight) and IR Dye A (15 parts by weight) in a solvent mixture of BLO:MEK:water:PGME (15:20:5:60 by weight). It was coated onto the individual substrates using a wire wound bar to provide a coating weight of 1.5 g/m² and dried at 104° C. for 90 seconds.

The outer layer formulation was coated onto the dried inner layer and comprised PD140A (69.5 parts), P3000 (30 parts), and ethyl violet (0.5 part) in DEK using a fixed hopper coater head drawn to an aluminum strip wrapped around a steel rotating drum to provide a dry coating weight of 0.7 g/m². The coating was then dried at 82° C. for 90 seconds.

### COMPARATIVE EXAMPLE 1

A typical process for the preparation of lithographic substrates was used to prepare what is identified herein as Substrate C1. An aluminum web was cleaned to remove mill oil and the thin natural oxide on the surface using a caustic alkali substance such as sodium hydroxide mixed with an agent to maintain the dissolving aluminum in solution, such as sodium gluconate. The web was then rinsed in an acidic bath to neutralize the surface. The web was subsequently electrochemically grained in 1.30% hydrochloric acid and 0.05% Al³⁺ in solution using an alternating current. The applied current density was 40 A/dm² and the charge density was 850 C/dm². After graining, the aluminum web was etched with a caustic alkali substance similar to the initial cleaning step. The etch activity was described as low, meaning the conductivity was 18 mS/cm at 25° C. The web was then neutralized in an acidic solution before it was anodized in sulfuric acid using a directly applied current for the purpose of hardening the surface. The web was then rinsed with water before an interlayer material such as polyvinyl phosphonic acid was applied, and further rinsed and dried prior to application of the imageable layer formulation. The interlayer protects the anodization from absorbing dye in the coated imageable layer. The problem with Substrate C1 was that it had inadequate general non-image blanket toning resistance. The current density used to prepare C1 was too low, leaving a significant amount of by-product from the electrochemical graining, known as “smut”, on the metal surface. The physical and chemical nature of smut leads to a reduction in the general blanket toning resistance so that the surface is more likely to attract and embed small ink particles on the substrate surface. The ink particles accumulate quickly once initiated, leading to a layer of unwanted ink in the non-image regions (background) of the printing plate. The unwanted ink eventually transfers to the printed sheets causing what is known as general blanket toning of the non-imaged areas. This result makes the printing plate useless. The details for Substrate C1 are shown in the following TABLE I.

TABLE I

| | Current | Charge | | | | General | Localized |
|---|---|---|---|---|---|---|---|
| Sub- | density | Density | Rv | Etch | OD | Blanket | Blanket |
| strate | (A/dm²) | (C/dm²) | (μm) | Activity | Plate | Toning | Toning |
| C1 | 40 | 850 | 3.51 | Low | 0.36 | 0.00 | No |

### COMPARATIVE EXAMPLE 2

Substrate C2 is another example of an aluminum-containing substrate having poor blanket toning performance. C2 had slightly improved general non-image toning resistance over Substrate C1, yet it still was not acceptable because it also had localized non-image toning problems. It was produced using the same process steps described above for preparing Substrate C1 with the exception that Substrate C2 was electrochemically grained using 0.70% hydrochloric acid and 0.28% Al³⁺ in solution at 30° C. at a current density of 44 A/dm² and a charge density of 950 C/dm². The charge density was too high and thus the resulting Rv was too high, enabling the imageable layer coating to remain in the pits after imaging and processing. When the element was used on the printing press, the embedded oleophilic coating attracted ink that then transferred to the printed sheets in the non-image regions (background) resulting in what is known as localized blanket toning. The details for Substrate C2 are shown in the following TABLE II.

TABLE II

| | Current | Charge | | | | General | Localized |
|---|---|---|---|---|---|---|---|
| Sub- | density | Density | Rv | Etch | OD | Blanket | Blanket |
| strate | (A/dm²) | (C/dm²) | (μm) | Activity | Plate | Toning | Toning |
| C2 | 44 | 950 | 4.56 | Low | 0.33 | 0.05 | Yes |

### COMPARATIVE EXAMPLES 3-6

Aluminum webs were conveyed through a plate production line using the processes similar to those used to prepare Substrates C1 and C2. The adjustments to make the improvements specific to this substrate were in the electrochemical graining process as described. The electrochemical graining charge density was decreased, which prevented the formation of deep pits, thereby preventing localized blanket toning. The substrates were grained using 0.98% hydrochloride acid and 0.16% Al³⁺. The post-graining etch solution was a sodium hydroxide and sodium gluconate mix (2.5:1 ratio) at a conductivity of 18 mS/cm at 25° C. The aluminum web was exposed to the etching solution for 13 seconds. Comparative Substrates C3 and C4 exhibited localized blanket toning. In addition, the Rv was too high for these substrates. Comparative Substrates C5 and C6 were prepared using a current density that was below 50 A/dm². The results are shown in the following TABLE III.

TABLE III

| | Current density | Charge Density | Rv | Localized |
|---|---|---|---|---|
| Substrate | (A/dm²) | (C/dm²) | (μm) | Blanket Toning |
| C3 | 45 | 832 | 4.7 | yes |
| C4 | 36 | 795 | 5.1 | yes |
| C5 | 46 | 684 | 3.12 | no |
| C6 | 35 | 652 | 3.17 | no |

### INVENTION EXAMPLE 1 AND COMPARATIVE EXAMPLE 7

This example shows the benefit of a higher current density in improving the general blanket toning resistance. In the electrochemical graining process, the current density was increased to 55 A/dm² with a charge density of 550 C/dm². The graining electrolyte was 0.95% hydrochloric acid and 0.15% Al³⁺ at 35° C. The higher current density led to a significant improvement in the general blanket toning resistance as shown for Substrate 1 in the following TABLE IV. Comparative Substrate C7 was not prepared according to the present invention because the current density was too low and exhibited general blanket toning due to the presence of unwanted smut. While this smut can be removed using an aggressive etch process (for example, removing more than 1.5 g/m² of metal), such a process will likely destroy the preferred graining structure by smoothing out the peaks and removing the fine pits within the large pits on the metal surface, both of which are needed to promote adequate adhesion of the imageable layer coatings to the substrate for acceptable run length.

TABLE IV

| | Current | Charge | | | | General | Localized |
|---|---|---|---|---|---|---|---|
| Sub- | density | Density | Rv | Etch | OD | Blanket | Blanket |
| strate | (A/dm²) | (C/dm²) | (μm) | Activity | Plate | Toning | Toning |
| C7 | 35 | 652 | 3.17 | Low | 0.33 | 0.06 | No |
| 1 | 55 | 590 | 3.38 | Low | 0.32 | 0.13 | No |

### INVENTION EXAMPLE 2

Similar to Invention Example 1, this example tests the high current density, but this time with use of the same graining chemistry used to prepare Substrate C1. The electrochemical graining chemistry was 1.3% hydrochloric acid and 0.50% Al³⁺ at 25° C. A significant improvement in general blanket toning resistance was observed for Substrate 2 using this graining chemistry as well as shown in the following TABLE V.

TABLE V

| | Current | Charge | | | | General | Localized |
|---|---|---|---|---|---|---|---|
| Sub- | density | Density | Rv | Etch | OD | Blanket | Blanket |
| strate | (A/dm²) | (C/dm²) | (μm) | Activity | Plate | Toning | Toning |
| C1 | 40 | 850 | 3.51 | Low | 0.36 | 0.00 | No |
| 2 | 55 | 588 | 3.24 | Low | 0.33 | 0.13 | No |

### INVENTION EXAMPLES 3 AND 4

Increasing the activity of the post-graining etch to remove aluminum hydroxide etch film by-product also provided a significant improvement in general blanket toning resistance. The etch solution was increased from 18 mS/cm at 25° C. to 60 mS/cm at 35° C. while the electrochemical graining chemistry for Substrates 3 and 4 was 1.3% hydrochloric acid and 0.50% Al³⁺ at 25° C. Less etch film on the surface was evident when measuring the optical density of the surface with an X-Rite 508 densitometer using the visual filter. The lower optical density corresponded to less etch film on the surface, which was verified by analyzing the surface with a SEM (see SEM photos below). While the resulting printing plates are considered an improvement, the printing plate of Invention Example 4 is preferred because it exhibited a significant improvement for both general and localized blanket toning resistance as shown in the following TABLE VI.

TABLE VI

| | Current | Charge | | | Optical | General | Localized |
|---|---|---|---|---|---|---|---|
| Sub- | density | Density | Rv | Etch | Density | Blanket | Blanket |
| strate | (A/dm²) | (C/dm²) | (μm) | Activity | of Plate | Toning | Toning |
| 3 | 50 | 506 | 2.59 | Low | 0.35 | 0.12 | No |
| 4 | 50 | 506 | 2.38 | High | 0.32 | 0.20 | No |

A dynamic contact angle measurement device was used to measure the affinity of the etch film for press fountain solution. First, a 18.6 dm² aluminum plate, alloy 3103, was dipped in a solution of 1.6% hydrochloric acid and 0.05% Al³⁺ and then electrochemically grained at 16 A/dm² and 1450 C/dm² at 26° C. to produce an etch film on a grained surface. The etch film for a similarly grained plate was removed with a heated stripping solution (1.9% CrO₃, 5.1% H₃PO₄ at 55° C.) to expose the underlying surface without the etch film layer. The two substrates were then anodized to chemically bond the etch film to the surface. The substrate (C9) that was stripped of the etch film before anodizing is the preferred surface over the substrate that was not stripped (C8). Another grained aluminum substrate was not stripped or anodized, leaving the etch film loosely adhered to the surface and is referred to as Substrate R1.

The device used for the contact angle measurements was a VCA Optima manufactured by AST Products, Inc. Each substrate was immersed in a beaker of soy oil and a 0.25 μm drop of fountain solution (142W-PAR) was placed on its surface. A video camera recorded the drop hitting and spreading on the substrate surface over a four-minute period. The commercially available VCA OptimaXE software program was used to measure the contact angle of the drop at 2 minutes and 4 minutes after impact. The lower angle corresponded to greater spreading of the fountain solution on the surface and the results are provided in the following TABLE VII.

TABLE VII

| | | Contact angle at | Contact angle |
|---|---|---|---|
| Substrate | Description | 120 seconds | at 240 seconds |
| R1 | Grained only | 155 | 155 |
| C8 | Grained, anodized | 120 | 111 |
| C9 | Grained, etch film | 91 | 79 |
| | stripped, anodized | | |

### INVENTION EXAMPLE 5

This example shows the effect of lower temperature electrochemical graining or lower charge density. Individual aluminum sheets were electrochemically grained and etched under the conditions shown in the following TABLE VIII to provide Substrates A through D with the noted properties.

TABLE VIII

| | Substrate | Substrate | Substrate | Substrate |
|---|---|---|---|---|
| | A | B | C | D |
| Graining: | | | | |
| HCl (g/l) | 15 | 15 | 13 | 13 |
| Al³⁺ (g/l) | 2.0 | 2.0 | 0.5 | 0.5 |
| Temperature (° C.) | 18 | 35 | 18 | 35 |
| A/dm² | 71 | 71 | 64 | 64 |
| C/dm² | 813 | 813 | 634 | 634 |
| Etching: | | | | |
| Etch loss (mg/m2) | 525 | 525 | 490 | 490 |
| Surface Properties: | | | | |
| Ra average (μm) | 0.51 | 0.53 | 0.50 | 0.44 |
| Ra range (μm) | 0.50–0.55 | 0.51–0.55 | 0.45–0.53 | 0.41–0.46 |
| Rv average (μm) | 3.11 | 4.27 | 3.97 | 4.47 |
| Rv range (μm) | 2.45–4.66 | 2.88–5.59 | 3.64–4.28 | 4.09–4.71 |

The change in the average Rv is seen as significant evidence that lower electrochemical graining temperature can be used to keep the pit depth below 4 μm. The acid and dissolved aluminum concentrations appear to cause a smaller effect than the lower temperature.

The invention has been described in detail with particular reference to certain preferred embodiments thereof, but it will be understood that variations and modifications can be effected within the spirit and scope of the invention.

1. An electrochemically grained metal sheet comprising aluminum that has a metal surface having a center line average roughness (Ra) of less than 0.60 μm and an average maximum pit depth (Rv) of less than 4.5 μm.

2. The electrochemically grained metal sheet of claim 1 having an Ra of from about 0.28 to about 0.60 μm and an Rv of from about 1.2 to about 4.5 μm.

3. The electrochemically grained metal sheet of claim 1 having an Rv of from about 1.2 to about 3.8 μm.

4. The electrochemically grained metal sheet of claim 1 wherein said metal surface is provided with an oxide film.

5. The electrochemically grained metal sheet of claim 1 wherein said metal surface has been treated to render it hydrophilic.

6. An imageable element comprising a metal substrate comprising aluminum, said metal substrate having one or more imageable layers disposed thereon, and said metal substrate having a surface having a center line average roughness (Ra) of less than 0.60 μm and an average maximum pit depth of less than 4.5 μm.

7. The imageable element of claim 6 having two or more layers disposed on said metal substrate from about one of which layers is an ink-receptive imageable layer.

8. The imageable element of claim 6 that is positive-working and comprises from about one ink-receptive imageable layer that upon exposure to imaging radiation, undergoes a change in solubility properties with respect to an alkaline developer in the irradiated regions of said imageable layer.

9. The imageable element of claim 6 that is positive-working and comprises on said metal substrate:
an inner layer comprising a first polymeric binder, and
an ink-receptive outer layer that comprises a second polymeric binder wherein said outer layer is insoluble in an aqueous alkaline developer before exposure to irradiation,
wherein said imageable element further comprises a radiation absorbing material that is located in either said inner layer, outer layer, or both inner and outer layers.

10. The imageable element of claim 9 wherein said radiation absorbing material is an IR-sensitive photothermal conversion material that is located in said inner layer only.

11. The imageable element of claim 9 wherein
said first polymeric binder contains pendant carboxy or phosphoric acid groups, an N-substituted cyclic imide, a pendant urea or cyclic urea, sulfonamide, or adamantyl group, and
said second polymeric binder contains phenolic hydroxyl groups, or is a norbomene-containing polymer, a maleic anhydride polymer, a methyl methacrylate polymer, a polymer having pendant epoxy groups, a carboxyphenyl maleimide-containing polymer, or a polymer containing pendant carboxy groups.

12. The imageable element of claim 6 that is a lithographic printing plate precursor.

13. A method of preparing a metal sheet comprising aluminum, said method comprising:
A) electrochemically graining a metal sheet comprising aluminum at a current density of at least 50 A/dm² and a charge density less than or equal to 850 coulombs/dm², and
B) etching the surface of said electrochemically grained metal sheet with an alkaline solution to remove at least 100 mg/m².

14. The method of claim 13 wherein said electrochemically graining is carried out at a current density of from about 50 to about 80 A/dm² and a charge density of from about 450 to about 750 coulombs/dm², and
the etching of said surface is carried out using a solution having a pH of at least 13 and comprising a hydroxide and a sequestering agent, at a conductivity of from about 30 to about 90 mS/cm at a temperature of from about 15 to about 45° C. to remove from about 100 to about 1000 mg/m².

15. The method of claim 13 further comprising, after steps A and B:
C) anodizing said electrochemically grained and etched metal sheet.

16. The method of claim 13 wherein said electrochemically graining is carried out in a stepwise fashion wherein each graining step is carried out at a different current density than the previous or succeeding graining step.

17. The method of claim 16 wherein said electrochemically graining is carried out in a stepwise fashion wherein each succeeding graining step is carried out at a higher current density than the previous graining step.

18. The method of claim 13 wherein said electrochemically graining is carried out at a temperature of from about 18 to about 50° C.

19. The method of claim 13 further comprising applying one or more imageable layers to said electrochemically grained and etched metal sheet.

20. An electrochemically-grained and etched aluminum-containing substrate prepared by the method of claim 13.
